(19) United States
(12) Patent Application Publication
(10) Pub. No.: US 2010/0322370 A1
(43) Pub. Date: Dec. 23, 2010

(54) PROCESS OF MANUFACTURING ZIRCONIUM ALLOY FOR FUEL GUIDE TUBE AND MEASURING TUBE HAVING HIGH STRENGTH AND EXCELLENT CORROSION RESISTANCE

(75) Inventors: Hyun Gil Kim, Daejeon (KR); Yong-Hwan Jeong, Daejeon (KR); Sang-Yoon Park, Daejeon (KR); Byoung-Kwon Choi, Daejeon (KR); Jeong-Yong Park, Daejeon (KR); Yang-II Jung, Daejeon (KR); Dong-Jun Park, Daejeon (KR)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignees: Korea Atomic Energy Research Institute, Daejeon (KR); Korea Hydro and Nuclear Power Co., Ltd., Seoul (KR)

(21) Appl. No.: 12/770,131

(22) Filed: Apr. 29, 2010

(30) Foreign Application Priority Data
May 29, 2009 (KR) 10-2009-0047526

(51) Int. Cl. G21C 3/06; C22F 1/18

(52) U.S. Cl. 376/412; 148/672

(57) ABSTRACT

A process of manufacturing zirconium alloy. The process may be used to make a nuclear fuel guide tube and/or a measuring tube which are main components of a nuclear fuel assembly structure. While a nuclear fuel guide tube and a measuring tube are manufactured by performing three-step cold working, and intermediate and final thermal annealing from a semi-finished TREX shell in the conventional method, the present invention relates to zirconium alloy undergoing two-step cold working, and intermediate and final thermal annealing from a TREX shell, resulting in enhanced strength and corrosion resistance. The present invention may be applied to a nuclear fuel guide tube and a measuring tube used for a nuclear fuel assembly in a light water nuclear reactor because, by the shortened process, high percentage reduction in thickness between processes and an decrease in thermal annealing time may sustain high strength and excellent corrosion resistance, and achieve economy of manufacture by reducing the number of processes.

### CROSS-REFERENCES TO RELATED APPLICATION

This patent application claims the benefit of priority from Korean Patent Application No. 10-2009-0047526, filed on May 29, 2009, the contents of which are incorporated herein by reference.

### BACKGROUND OF THE INVENTION

1. Field of the Invention

The present invention relates to a process of manufacturing zirconium alloy for a fuel guide tube and a measuring tube, and more particularly to process of manufacturing such tubes having high strength and excellent corrosion resistance.

2. Description of the Related Art

In structure of a nuclear reactor in nuclear power plant, due to high-temperature and high-pressure corrosive environment and neutron irradiation, performance degradation by deterioration results in a decrease in safety and economy of the nuclear reactor. In particular, since zirconium alloy parts such as a nuclear fuel rod cladding tube, a nuclear fuel guide tube, a measuring tube, and a spacer grid, which are used for nuclear fuel assembly in a nuclear reactor, are accompanied by integrity degradation due to growth of an oxide film and mechanical deformation caused by corrosion reaction, an alloy composition and a manufacturing process are very important.

A nuclear fuel guide tube, which is connected with an upper and lower end fitting and a spacer grid in a nuclear fuel assembly to thereby form a skeleton for the nuclear fuel assembly, supports a load of fuel rods in the assembly, and sustains rigidity and structural continuity of the nuclear fuel assembly. Thus, a nuclear fuel guide tube should achieve excellent mechanical strength, compared to other structural parts of the assembly. Zirconium alloy is used for material of a nuclear fuel guide tube, as the case for a nuclear fuel rod cladding tube.

Recently, as part of economic improvement of a nuclear reactor, high-burnup/long-cycle operation where replacement cycle of nuclear fuel is extended to save nuclear fuel cycle costs, is being employed. A reaction period taken for a nuclear fuel assembly to react with high-temperature and high-pressure cooling water and vapor is extended according to the extended replacement cycle of nuclear fuel, and thereby corrosion amounts of a nuclear fuel guide tube and a measuring tube increase. Hydrogen introduced into a nuclear fuel guide tube and a measuring tube by corrosion reaction forms hydrides, and the formed hydrides degrade the integrity of a nuclear fuel assembly because the hydrides cause mechanical strengths of the nuclear fuel guide tube and measuring tube to be decreased and an amount of irradiation growth resulted from hydride formation to be increased.

Thus, it is necessary to develop a nuclear fuel guide tube and a measuring tube which have excellent corrosion resistance to high-temperature and high-pressure cooling water and vapor, achieve high strength, and are available for a high-burnup/long-cycle nuclear fuel assembly.

A nuclear fuel assembly, as illustrated in FIG. 1, includes: a skeleton having an upper end fitting 4, a lower end fitting 5, a spacer grid 2, a guide tube 3 and a measuring tube 6; and a fuel rod supported by springs and dimples charged and formed into the spacer grid 2.

Specifications of a nuclear fuel guide tube and a measuring tube, as illustrated in FIG. 2, are classified according to the form of a nuclear fuel assembly such a Korean Standardized Nuclear Plant (PLUS7) and a Westinghouse type plant (17ACE7).

A nuclear fuel guide tube and a measuring tube used in a Korean Standardized Nuclear Plant (PLUS7), with 24.89 mm in outer diameter (OD) and 0.98 mm in wall thickness (WT), have twice the outer diameter and wall thickness of those used in a Westinghouse type plant (17ACE7) with 12.24 mm OD and 0.482 mm WT.

However, a nuclear fuel guide tube and a measuring tube, currently manufactured worldwide, for a Korean Standardized Nuclear Plant (PLUS7) are being manufactured from a TREX shell, a semi-finished product for a zirconium tube of the same size using a three-step manufacturing process (see FIG. 3), which is the same with a manufacturing method of a nuclear fuel guide tube and a measuring tube applied to a Westinghouse type plant (17ACE7) with a very small OD and WT.

### SUMMARY OF THE INVENTION

In an embodiment, the present invention provides a method of manufacturing zirconium alloy for a nuclear fuel guide tube and a measuring tube for a Korean Standardized Nuclear Plant (PLUS7), which achieves high strength and sustains corrosion resistance under high-burnup/long-cycle operation.

In another embodiment, the present invention provides a simple process of manufacturing zirconium alloy for a nuclear fuel guide tube or a measuring tube for use in a Korean Standardized Nuclear Plant (PLUS7) from a TREX shell that is a semi-finished product, by changing the current three-step manufacturing process into a two-step manufacturing process, and a method of controlling a range of percentage reduction in thickness and thermal annealing for each step of the process.

In a further embodiment, the present invention provides a method of manufacturing zirconium alloy, including performing an intermediate thermal annealing after primarily cold working a TREX shell, a semi-finished product for manufacturing a zirconium alloy tube, and performing a final thermal annealing after secondarily cold working an intermediate product which underwent the intermediate thermal annealing. The final thermal annealing step provides a product, a zirconium alloy tube, that may be further processed into or used for a nuclear fuel guide tube or a nuclear fuel measuring tube.

The zirconium alloy may include at least one of elements such as niobium (Nb), tin (Sn), iron (Fe), chromium (Cr) and copper (Cu), with the balance being zirconium (Zr). The zirconium alloy may include at least one of these elements in the weight percent (wt %) range indicated: 0.01 to 2.0 wt % of Nb, 0.01 to 1.8 wt % of Sn, 0.01 to 1.0 wt % of Fe, 0.01 to 1.0 wt % of Cr and 0.01 to 0.5 wt % of Cu.

Each percentage reduction in thickness for the primary and secondary cold working may be 55% to 80%.

The intermediate thermal annealing may be performed at 580±20° C., and the final thermal annealing may be performed at 450° C. to 550° C.

### BRIEF DESCRIPTION OF THE DRAWINGS

The invention in its various embodiments will be more clearly understood from the following detailed description taken in conjunction with the accompanying drawings, in which:

FIG. 1 is a schematic diagram illustrating a general nuclear fuel assembly;

FIG. 2 is a schematic diagram illustrating specification of a nuclear fuel guide tube in a nuclear fuel assembly used in a Korean Standardized Nuclear Plant (PLUS7) and a Westinghouse type plant (17ACE7);

FIG. 3 is a schematic diagram illustrating a manufacturing process of a nuclear fuel guide tube in a nuclear fuel assembly used in a Korean Standardized Nuclear Plant (PLUS7) and a Westinghouse type plant (17ACE7); and

FIG. 4 is a schematic diagram comparing a two-step manufacturing process (2-pass, a new process) of a nuclear fuel guide tube in use for a Korean Standardized Nuclear Plant (PLUS7) having high strength and excellent corrosion resistance according to the present invention with a three-step manufacturing process (3-pass, a current process).

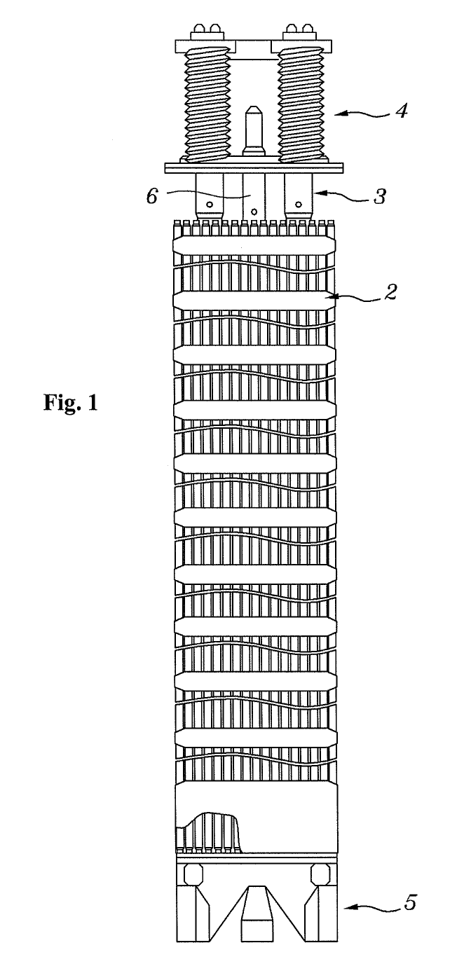

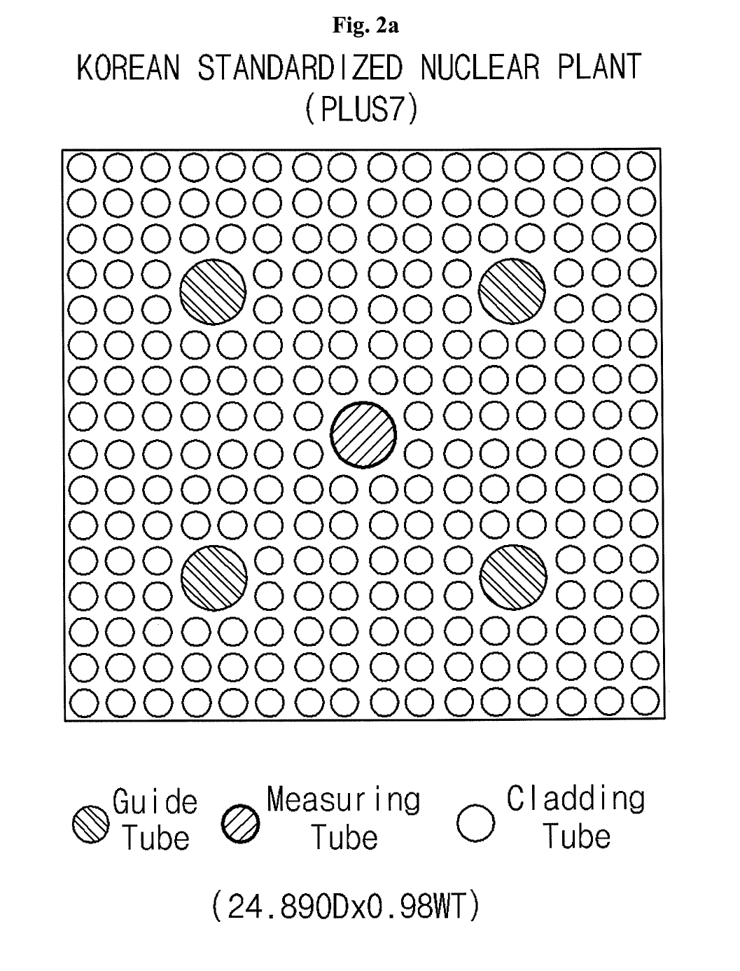

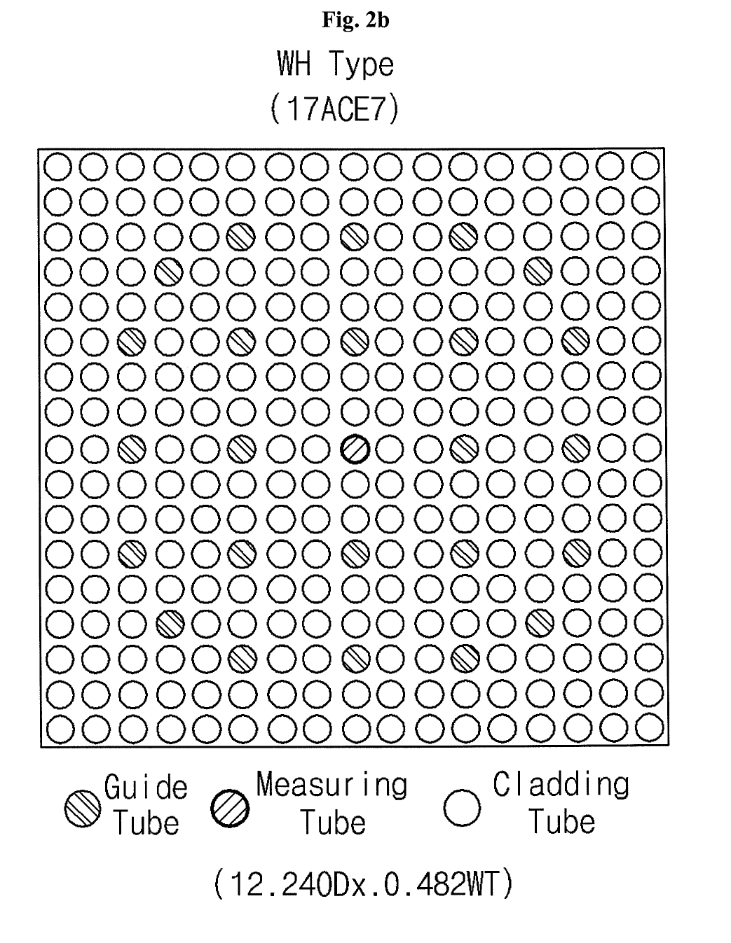

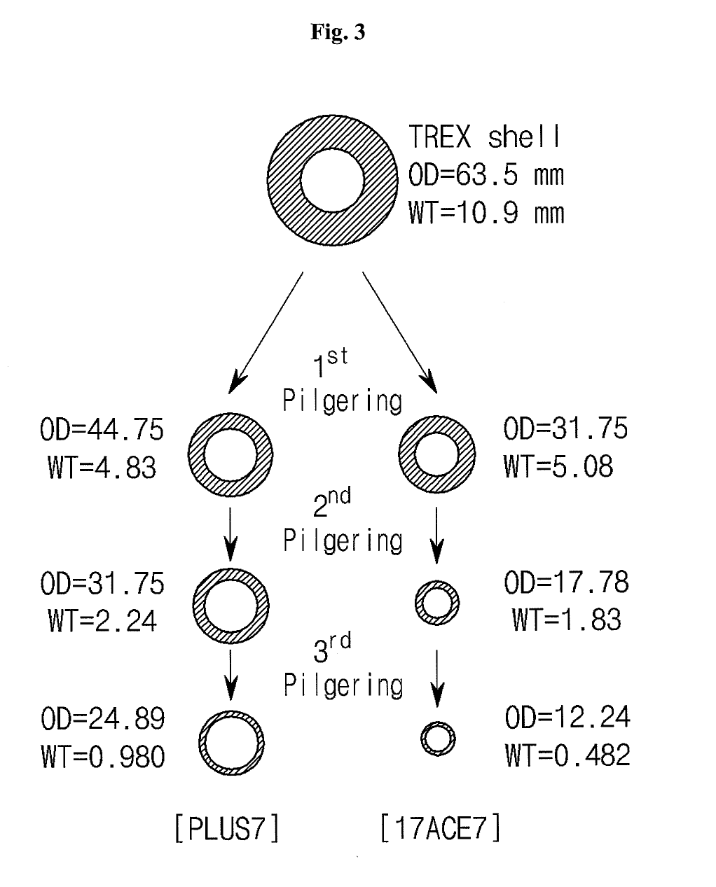

### DETAILED DESCRIPTION

Applicants have investigated a measure of improving high strength achievement and an increase in hydride formation caused by an increase in a corrosion amount from high-burnup/long-cycle operation, which are mostly required for a nuclear fuel guide tube and a measuring tube made of zirconium alloy as component parts of a nuclear fuel assembly in a commercially available nuclear reactor.

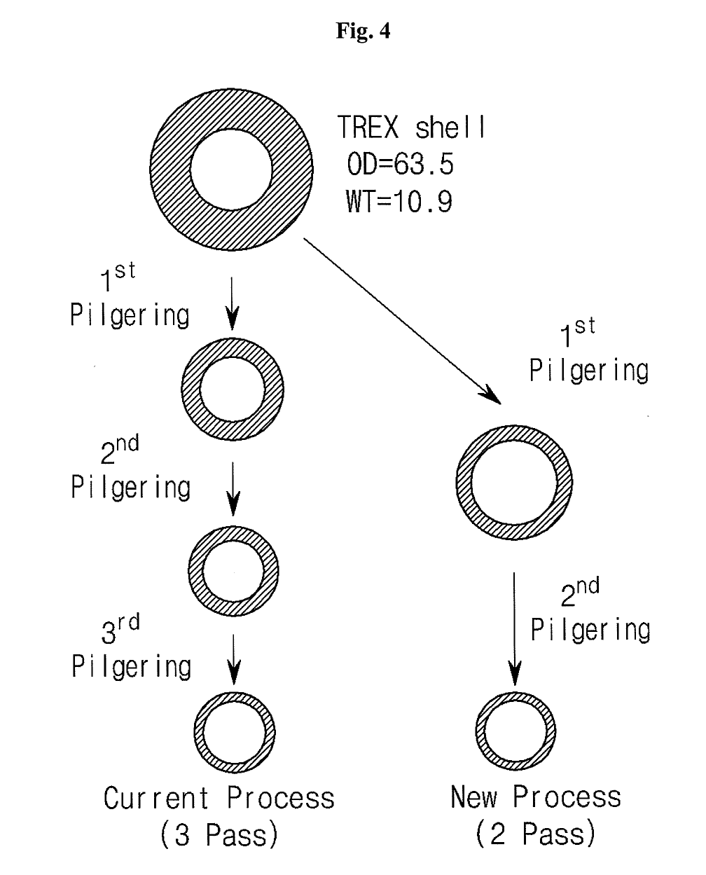

In particular, the Applicants have investigated an improvement in a method of manufacturing a nuclear fuel guide tube and a measuring tube in use for a Korean Standardized Nuclear Plant (PLUS7) with increased OD and WT, compared to specifications of a nuclear fuel guide tube and a measuring tube applied to a Westinghouse type plant (17ACE7). The diameter and thickness of a nuclear fuel guide tube in use for a Korean Standardized Nuclear Plant (PLUS7) are relatively large. Therefore, it is found that, if a nuclear fuel guide tube is manufactured from a TREX shell, a semi-finished product for a zirconium tube, using a two-step manufacturing process, a shortened manufacturing process compared to the conventional three-step manufacturing process gives economic benefits and enhances strength because a texture can be densified owing to an increase in processed quantity for each step (FIG. 4).

Based on the results of their investigation, the Applicants completed the present invention by confirming that it is possible to manufacture a nuclear fuel guide tube and a measuring tube for a Korean Standardized Nuclear Plant (PLUS7) from a zirconium alloy TREX shell through a two-step manufacturing process. Further, the Applicants have found that in some embodiments, it is possible to achieve high strength and corrosion resistance and/or improve economic benefits when manufacturing a nuclear fuel guide tube and a measuring tube for a Korean Standardized Nuclear Plant (PLUS7) from a zirconium alloy TREX shell through a two-step manufacturing process instead of the conventional three-step manufacturing process.

Zirconium alloys with high strength and excellent corrosion resistance which may be used as structural materials for a nuclear fuel guide tube and a measuring tube of nuclear fuel assembly used under high-burnup/long-cycle operation will be manufactured through embodiments of a process according to the invention.

The zirconium alloy may include at least one of elements such as niobium (Nb), tin (Sn), iron (Fe), chromium (Cr) and copper (Cu), with the balance being zirconium (Zr), and the composition may be at least on of 0.01 to 2.0 wt % of Nb, 0.01 to 1.8 wt % of Sn, 0.01 to 1.0 wt % of Fe, 0.01 to 1.0 wt % of Cr and 0.01 to 0.5 wt % of Cu.

Hereinafter, embodiments of the present invention will be described in detail.

In order to obtain zirconium alloys with high strength and excellent corrosion resistance in use for a nuclear fuel guide tube and a measuring tube, a manufacturing process is simplified from a current three-step manufacturing process into a two-step manufacturing process, and a range of percentage reduction in thickness and a temperature of thermal annealing, which are introduced into each manufacturing step, are controlled.

The percentage reduction in thickness is expressed as a ratio of a thickness difference between before-rolling and after-rolling plates to the thickness of the before-rolling plate, and is thus obtained from following Equation 1

R=(t1−t2)/t1, or R=(t1−t2)×100/t1(%) (Eq. 1)

where R is a percentage reduction in thickness, t1 is a thickness of plate before rolling, and t2 is a thickness of plate after rolling.

In order to enhance the economy of the method of manufacturing a nuclear fuel guide tube and a measuring tube from a zirconium alloy TREX shell, as illustrated in FIG. 4, the current three steps were reduced into two steps. A percentage reduction in thickness for each step is 55%, 53%, 56% for the current three-step manufacturing process, whereas, according to the present invention, a percentage reduction in thickness for each step is 55% to 80% for the two-step manufacturing process in order to make a final tube product 0.98 mm thick.

With respect to a temperature of an intermediate thermal annealing performed after cold working, a temperature range of the intermediate thermal annealing is extended to 580±20° C., from the current annealing temperature condition of 596±8° C. As for a temperature of a final thermal annealing performed after completion of the process, a temperature of the final thermal annealing is extended to a range of 450° C. to 550° C. from the current annealing temperature condition of 454° C. to 471° C.

The reason to possibly extend the temperature range for the intermediate and final thermal annealing is that a decrease in corrosion resistance, due to precipitate coarsening by an increase in annealing temperature and time, may be reduced because the intermediate thermal annealing occurs once only by a reduction from three steps into two steps.

Also, an increase in final thermal annealing temperature causes strengths of the nuclear fuel guide tube and measuring tube to be decreased but a resistance to irradiation growth to be increased. Thus, the increase in final thermal annealing temperature may lead to an increase in resistance to irradiation growth due to an increase in strength by applying two-step manufacturing process.

Hereinafter, the present invention will be described in more details with reference to the following examples and experimental examples. However, the following examples and experimental examples are provided for illustrative purposes only, and the scope of the present invention should not be limited thereto in any manner.

### Example 1

### Manufacture of Zirconium Alloy for a Nuclear Fuel Guide Tube from a Zirconium Alloy TREX Shell

(1) Cold Working Process

From a Zr-1.0Nb-1.0Sn-0.1Fe alloy TREX shell (outer diameter: 63.5 mm, wall thickness: 10.9 mm), a semi-finished product for a zirconium alloy tube, a product of a nuclear fuel guide tube with a final thickness of 0.98 mm was manufactured by applying a two-step cold working process with the following 3 types of percentage reduction in thickness.

2a: 78% primary cold working and 59% secondary cold working

2b: 70% primary cold working and 70% secondary cold working

2c: 58% primary cold working and 79% secondary cold working

(2) Intermediate Thermal Annealing

An intermediate thermal annealing of the cold-worked materials was performed by using vacuum annealing reactor at 570(±10)° C. for 2 hours.

(3) Final Thermal Annealing

After cold working of an intermediate product which underwent intermediate thermal annealing, a final thermal annealing of the product was performed by using vacuum annealing reactor at 460(±10)° C. for 7 hours.

### Example 2 to 5

### Manufacture of Zirconium Alloy for a Nuclear Fuel Guide Tube from a Zirconium Alloy TREX Shell

From a TREX shell, a semi-finished product for a zirconium alloy tube, a nuclear fuel guide tube with high strength and excellent corrosion resistance was manufactured by applying the same two-step manufacturing process used in Example 1 except for a chemical composition of the composition. A chemical composition of the zirconium alloy TREX shell composition is indicated in Table 1 below.

### Comparative Example 1

### Manufacture of Zirconium Alloy for a Nuclear Fuel Guide Tube from a Zirconium Alloy TREX Shell

(1) Cold Working Process

Alloys of Comparative Examples 1 to 2 were manufactured using the current three-step cold working process and a chemical composition obtained from a TREX shell, a semi-finished product for a zirconium alloy tube. The chemical composition of the zirconium alloy composition is indicated in Table 1 below. The comparative examples were prepared using the following percentage reductions:

3a: 55% primary cold working, 53% secondary cold working, 56% tertiary cold working

(2) Intermediate Thermal Annealing

An intermediate thermal annealing was performed on the cold worked material using vacuum annealing reactor at 596(±10)° C. for 3.5 hours after primary and secondary cold working.

(3) Final Thermal Annealing

After cold working of an intermediate product which underwent the intermediate thermal annealing, a final thermal annealing was performed on the intermediate product using vacuum annealing reactor at 464(±10)° C. for 7 hours.

### Comparative Example 2

### Manufacture of Zirconium Alloy for a Nuclear Fuel Guide Tube from a Zirconium Alloy TREX Shell

Zirconium alloys for a nuclear fuel guide tube were manufactured by the same method of Comparative Example 1 using a zirconium alloy composition listed in Table 1.

TABLE 1

| | Percentage | | | | | | |
|---|---|---|---|---|---|---|---|
| | reduction | | | | | | |
| | in | Chemical Composition (wt %) | | | | | |
| | thickness | Niobium | Tin | Iron | Chromium | Copper | Zirconium |
| Division | condition | (Nb) | (Sn) | (Fe) | (Cr) | (Cu) | (Zr) |
| Example 1 | 2a, 2b, 2c | 1.0 | 1.0 | 0.1 | — | — | Balance |
| Example 2 | 2b | 1.5 | 0.4 | 0.2 | 0.1 | — | Balance |
| Example 3 | 2a, 2b, 2c | 0.4 | 0.8 | 0.35 | 0.15 | 0.1 | Balance |
| Example 4 | 2b | 1.1 | — | — | — | 0.05 | Balance |
| Example 5 | 2b | — | 1.5 | 0.2 | 0.1 | — | Balance |
| Comparative | 3a | 1.5 | 0.4 | 0.2 | 0.1 | — | Balance |
| Example 1 | | | | | | | |
| Comparative | 3a | 0.4 | 0.8 | 0.35 | 0.15 | 0.1 | balance |
| Example 2 | | | | | | | |

### Experimental Example 1

### Tensile Test

A tensile test as below was performed for evaluation of mechanical strength of alloy composition in use for a nuclear fuel guide tube with an improved manufacturing process to achieve high strength and corrosion resistance of the present invention.

A tensile test was performed according to ASTM B810-01 Standard Test Method of the Examples 1 to 5 and Comparative Examples 1 to 2. Evaluation specimens for tension property were prepared according to requirements of ASTM E8 and were used for calculation of elongation with a mark of 50 mm gage length. A tensile test was performed at room temperature at a strain rate of 0.005±0.002 mm/mm/min, and the tensile test result is listed in Table 2.

According to Table 2, alloys in Examples 1, 2, 3 and 5, which was manufactured by the two-step manufacturing process of the present invention, were enhanced by 50% yield strength, by 9% maximum tension strength and by 65% elongation, compared to a commercially available guide tube standard.

Furthermore, alloy in Example 4, which contains relatively less alloy components and amount thereof, was enhanced by 20% yield strength, by 2% maximum tension strength and by 210% elongation.

Thus, zirconium alloy composition, which was manufactured by the two-step manufacturing process, was found to have strength much above commercially available nuclear fuel guide tube standard.

Example 1 and Comparative Example 1; and Example 3 and Comparative Example 2 evaluate tension property after respective two-step manufacturing process and three-step manufacturing process of alloys with the same composition.

Alloy of Example 2 with two-step manufacturing process, compared to alloys with the same composition in Comparative Example 1 with two-step manufacturing process, showed that it was enhanced by 7.5% yield strength, by 7.8% maximum tension strength and retained similar elongation.

Also, an alloy of Example 3 with two-step manufacturing process, compared to alloys with the same composition in Comparative Example 2 with two-step manufacturing process, showed that it was enhanced by 7% yield strength, by 7% maximum tension strength and retained similar elongation.

The result revealed that yield strength and maximum tension strength were enhanced by 7% with elongation kept if a nuclear fuel guide tube is manufactured with the two-step manufacturing process of the present invention from the three-step manufacturing process with respect to the same alloy composition.

A change in condition of percentage reduction in thickness for the two-step manufacturing process, which was evaluated for alloys of Examples 1 and 3, was revealed to have no effect on strength. A final nuclear fuel guide tube product is easily manufactured from a TREX shell because high strength is sustained and high margin is retained for change of percentage reduction in thickness if two-step manufacturing process is performed compared to the three-step manufacturing process.

### Experimental Example 2

### Corrosion Test

Specimens of zirconium alloys with 25×15×1 mm in length were prepared for Examples 1 to 5 and Comparative Examples 1 to 2, and dipped into a solution, in which a volume ratio of water:nitric acid:hydrofluoric acid is 50:40:10, to thereby remove deficits minutely present on the surface and impurities thereon.

Surface area and initial weight were measured for the surface-treated specimens before charged into autoclave.

Then, after the specimens underwent corrosion in 400-° C. cooling water for a predetermined time, a quantitative assessment of extent of corrosion was performed by measuring an increase in weight for specimens and by calculating an increased amount of weight relative to surface area. The result of the corrosion test was listed in Table 2. Standard specification of a commercially available nuclear fuel guide tube with respect to assessment of corrosion property was not elevated above 22 mg/dm² in an weight increase after 3-day test at 400° C., and an weight increase in alloys with compositions of Examples and Comparative Examples of the present invention was below 20 mg/dm², which satisfies the standard specification.

Table 2 indicates the results of a 60-day corrosion test, and Examples 1 to 5 with zirconium alloy composition according to the present invention showed that its weight gain was 44.3 mg/dm² to 48.8 mg/dm² in vapor environment. Comparing the same composition alloys of Example 2 and Comparative Example 1 to alloys of Example 3 and Comparative Example 2, the application of two-step manufacturing process, compared to three-step manufacturing process, was shown to decrease its weight gain by 4 mg/dm² to 5 mg/dm².

Thus, it was found that corrosion resistance was also enhanced when a nuclear fuel guide tube was manufactured by two-step manufacturing process of the present invention from the current three-step manufacturing process with respect to the same alloy composition.

TABLE 2

| | | | | | Results of |
|---|---|---|---|---|---|
| | | | | | assessment |
| | | | | | of |
| | | | | | corrosion |
| | | Results of assessment of | | | property |
| | | tension property | | | 400° C. |
| | Percentage | Test results at room temperature | | | Vapor 60 |
| | reduction | | Maximum | | days |
| | in | Yield | tension | | Weight |
| | thickness | strength | strength | Elongation, | gain, |
| Division | condition | MPa | MPa | % | mg/dm² |
| Example 1 | 2a | 633 | 705 | 20.3 | 48.2 |
| | 2b | 638 | 712 | 19.8 | 48.5 |
| | 2c | 642 | 720 | 19.0 | 48.8 |
| Example 2 | 2b | 643 | 724 | 20.4 | 45.6 |
| Example 3 | 2a | 625 | 700 | 21.6 | 45.3 |
| | 2b | 631 | 708 | 21.0 | 46.1 |
| | 2c | 635 | 714 | 20.1 | 45.8 |
| Example 4 | 2b | 513 | 655 | 25.6 | 44.3 |
| Example 5 | 2b | 640 | 720 | 19.2 | 46.4 |
| Compar- | 3a | 597 | 671 | 19.2 | 52.3 |
| ative | | | | | |
| Example 1 | | | | | |
| Compar- | 3a | 590 | 662 | 20.3 | 51.1 |
| ative | | | | | |
| Example 2 | | | | | |

| | | | | |
|---|---|---|---|---|
| Standard strength | 421 | 641 | 12 | — |
| specification of | | | | |
| nuclear fuel guide | | | | |
| tube | | | | |

As described above, zirconium alloys in use for a fuel guide tube and a measuring tube prepared according to the method of the present invention can be usefully utilized as a structure of nuclear fuel assembly of a commercially available nuclear power plant in order to achieve economy of manufacture by simplifying the current three-step manufacturing process into a two-step manufacturing process and in order to achieve corrosion resistance under high-burnup/long-cycle operation by controlling range of percentage reduction in thickness and thermal annealing introduced into each manufacturing step.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of manufacturing zirconium alloy, comprising:
performing an intermediate thermal annealing after primarily cold working a TREX shell, a semi-finished product for a zirconium alloy tube; and
performing a final thermal annealing after secondarily cold working an intermediate product which underwent the intermediate thermal annealing.

2. The method as set forth in claim 1, wherein the zirconium alloy comprises at least one element selected from niobium(Nb), tin(Sn), iron(Fe), chromium(Cr), and copper(Cu), with the balance being zirconium.

3. The method as set forth in claim 1, wherein the zirconium alloy comprises at least one of 0.01 to 2.0 wt % of niobium(Nb), 0.01 to 1.8 wt % of tin(Sn), 0.01 to 1.0 wt % of iron(Fe), 0.01 to 1.0 wt % of chromium(Cr), and 0.01 to 0.5 wt % of copper(Cu).

4. The method as set forth in claim 1, wherein each percentage reduction in thickness for the primary and secondary cold working ranges from 55% to 80%.

5. The method as set forth in claim 1, wherein the intermediate thermal annealing is performed at 580±20° C.

6. The method as set forth in claim 1, wherein the final thermal annealing is performed at 450° C. to 550° C.

7. The method of claim 1, further comprising using the zirconium alloy tube as a nuclear fuel guide tube.

8. The method as set forth in claim 7, wherein the zirconium alloy comprises at least one element selected from niobium(Nb), tin(Sn), iron(Fe), chromium(Cr), and copper(Cu), with the balance being zirconium.

9. The method as set forth in claim 7, wherein the zirconium alloy comprises at least one of 0.01 to 2.0 wt % of niobium(Nb), 0.01 to 1.8 wt % of tin(Sn), 0.01 to 1.0 wt % of iron(Fe), 0.01 to 1.0 wt % of chromium(Cr), and 0.01 to 0.5 wt % of copper(Cu).

10. The method as set forth in claim 7, wherein each percentage reduction in thickness for the primary and secondary cold working ranges from 55% to 80%.

11. The method as set forth in claim 7, wherein the intermediate thermal annealing is performed at 580±20° C.

12. The method as set forth in claim 7, wherein the final thermal annealing is performed at 450° C. to 550° C.

13. The of claim 1, further comprising using the zirconium alloy tube as a nuclear fuel measuring tube.

14. The method as set forth in claim 13, wherein the zirconium alloy comprises at least one element selected from niobium(Nb), tin(Sn), iron(Fe), chromium(Cr), and copper(Cu), with the balance being zirconium.

15. The method as set forth in claim 13, wherein the zirconium alloy comprises at least one of 0.01 to 2.0 wt % of niobium(Nb), 0.01 to 1.8 wt % of tin(Sn), 0.01 to 1.0 wt % of iron(Fe), 0.01 to 1.0 wt % of chromium(Cr), and 0.01 to 0.5 wt % of copper(Cu).

16. The method as set forth in claim 13, wherein each percentage reduction in thickness for the primary and secondary cold working ranges 55% to 80%.

17. The method as set forth in claim 13, wherein the intermediate thermal annealing is performed at 580±20° C.

18. The method as set forth in claim 13, wherein the final thermal annealing is performed at 450 to 550° C.
